(19) United States
(12) Patent Application Publication
(10) Pub. No.: US 2004/0091104 A1
(43) Pub. Date: May 13, 2004

(54) Parallel stream operation apparatus, method therefor, and parallel stream operation program

(76) Inventors: Osamu Kawamura, Kadoma-shi (JP); Masataka Osaka, Osaka-shi (JP)

Correspondence Address: SNELL & WILMER LLP, 1920 MAIN STREET, SUITE 1200, IRVINE, CA, 92614-7230, US

(21) Appl. No.: 10/634,507

(22) Filed: Aug. 5, 2003

(30) Foreign Application Priority Data
Aug. 27, 2002 (JP) 2002-247693

(51) Int. Cl. H04L 9/00

(52) U.S. Cl. 380/28

(57) ABSTRACT

A parallel stream operation apparatus in which selecting keys for encrypting or decrypting stream data input in parallel is simplified. A plurality of paths that correspond respectively to a plurality of keys for encrypting and/or decrypting stream data are provided. Stream data received by a first interface is decrypted with a first decryption key, and stream data received by a second interface is decrypted with a second decryption key. An input stream processing unit outputs the stream data received by the first input unit to a first path corresponding to the first decryption key, and outputs the stream data received by the second input unit to a second path corresponding to the second decryption key. An operation unit decrypts the stream data from the first path with the first decryption key and the stream data from the second path with the second decryption key.

### BACKGROUND OF THE INVENTION

1. Field of the Invention

The present invention relates to a parallel stream operation apparatus that encodes and decodes a plurality of data streams, in a TV reception apparatus that has a recording apparatus for recording received programs.

2. Description of the Related Art

In recent years TV reception apparatuses have come to be used in various ways. TV reception apparatuses are used not only to receive and televise programs broadcast from television stations, but also, for example, to receive and show Internet broadband broadcast programs via communication lines, store received programs in an HDD or the like, and view stored programs later. In addition, TV reception apparatuses are also used for playing back contents such as those on commercially packaged DVDs (digital versatile disks).

Content such as a broadcast program is broadcast in an encrypted form in order to protect copyright of the broadcast program, and therefore must be decrypted. Furthermore, when recording decrypted content to a recording medium, there are cases in which it is necessary to re-encrypt the content before recording.

FIG. 1 is s structural diagram of a conventional parallel stream operation apparatus that is part of a TV reception apparatus.

The parallel stream operation apparatus includes input interfaces 1601 to 1605, a stream analysis unit 1610, a control unit 1611, a stream processing unit 1621, keys 1631 to 1634, a selector 1635, a transfer mediation unit 1651, an operation unit 1661, a selector 1671, and output interfaces 1681 to 1685.

The following describes, as an example, a case in which a data stream of a program for viewing (hereinafter referred to as a “viewing program”) is input through the input interface 1601 and a data stream of a program for recording (hereinafter referred to as a “recording program”) is input through the input interface 1602, the two encrypted streams are decrypted by the operation unit 1661, and the decrypted data streams of the viewing program and the recording program are output from the output interface 1681 and the output interface 1682, respectively.

A decryption key for decrypting the viewing program is set in the key 1631, and a decryption key for decrypting the recording program is set in the key 1632.

For each of the data streams from the input interface 1601 and the input interface 1602, the stream analysis unit 1610 extracts header information from a packet of the data stream. The stream analysis unit 1610 notifies the control unit 1611 of whether the extracted PID matches the PID of the viewing program in the case of the data stream from the input interface 1601, and when the PIDs match, the control unit 1611 instructs the input interface 1601 to output the packet to the stream processing unit 1621. When the PIDs do not match, the control unit 1611 instructs the input interface 1601 to discard the packet. The stream analysis unit 1610,notifies the control unit 1611 of whether the extracted PID matches the PID of the recording program in the case of the data stream from the input interface 1602, and when the PIDs match, the control unit 1611 instructs the input interface 1602 to output the packet to the stream processing unit 1621. When the PIDs do not match, the control unit 1611 instructs the input interface 1602 to discard the packet. Furthermore, the control unit 1611 notifies the stream processing unit 1621 of which of the input interfaces 1601 and 1602 the packet being processed is from.

The input stream processing unit 1621 converts the format of the input packet, and outputs the resulting converted packet to the operation unit 1661. When doing so, the input stream unit 1621 notifies the transfer mediation unit 1651 of which of the input interfaces 1601 and 1602 the data is from.

When the data output by the stream processing unit 1621 to the operation unit 1661 is data from the input interface 1601, the transfer mediation unit 1651 instructs the selector 1635 to notify the operation unit 1661 of the decryption key 1631. When the output data is from the input interface l602, the transfer mediation unit 1651 instructs the selector 1635 to notify the operation unit 1661 of the decryption key 1632.

The operation unit 1661 decrypts the data input from the stream processing unit 1621 with the decryption key 1631 notified by the selector 1635, when the data is from the input interface 1601, or the decryption key 1632 notified by the selector 1635, when the data is from the input interface 1603. When decryption is complete, the operation unit 1661 outputs the decrypted data to the selector 1671, and notifies the transfer mediation unit 1651.

The transfer mediation unit 1651 instructs the selector 1671 to output the decrypted data to the output interface 1681 when the data is from the input interface 1601, and to the output interface 1682 when the data is from the input interface 1602. The selector 1671 outputs the decrypted data received the operation unit 1661, as instructed by the transfer mediation unit 1651.

In the conventional parallel stream operation apparatus, it is necessary when decrypting data in the operation unit 1661 for the selector 1635 to select either the decryption key 1631 or the decryption key 1632 every time a data input is received from the stream processing unit 1621.

The control procedure for the selector to select the decryption key 1631 or 1632 is complicated.

### SUMMARY OF THE INVENTION

In view of the stated problem, the object of the present invention is to provide a parallel stream operation apparatus that avoids complicated key selection and improves throughput of encryption and decryption of stream data that is input in parallel, and a method therefor.

The stated object can be achieved by A parallel stream operation apparatus, including: a plurality of paths, each corresponding to a different one of a plurality of keys used for encrypting and/or decrypting data streams; an input stream processing unit operable to receive a plurality of data streams in parallel, and output each data stream to a corresponding one of the paths; and an operation unit operable to decrypt or encrypt each data stream with a corresponding one of the keys.

According to the stated structure, the operation unit is able to encrypt or decrypt a data stream using a key that corresponds to the path from which the data stream was input. Therefore, it is not necessary to select a key each time a data stream is input, and the control procedure is simplified.

Furthermore, the parallel stream operation apparatus may further include: an output stream processing unit operable to receive the plurality of data streams that have been decrypted or encrypted by the operation unit, and output each received data stream to a different one of a plurality of output interfaces.

According to the stated construction, the encrypted or decrypted data stream can be output to an appropriate output interface.

Furthermore, the output stream processing unit may include a crossbar switch, and the parallel stream operation apparatus may further include: a switch control unit operable to set each contact point in the crossbar switch on or off, thereby setting a plurality of output interfaces as output destinations to which the output stream processing unit is to output the encrypted or decrypted data streams, the output interfaces being determined according to which of the paths the data streams were output to by the input stream processing unit; and a notification unit operable to receive each data stream from the paths, output each received data stream and the corresponding key to the operation unit, and notify the switch control unit of path information of each input data stream.

According to the stated structure, output interfaces can easily be set as output destinations of encrypted or decrypted data streams.

Furthermore, the operation unit may be one of a plurality of operation units in the parallel stream operation apparatus, and the parallel stream operation apparatus may further include: a notification unit operable to receive the plurality of data streams from the paths, input in parallel each of the plurality of received data streams and the corresponding key to a different one of the operations units, and notify each operation unit of path information of the data stream input to the operation unit; and a selection control unit operable, for each of the encrypted or decrypted data streams output from the output stream processing unit, to select, according to the path information of the data stream, an output interface as an output destination of the data stream.

According to the stated structure, encryption or decryption can be performed in parallel, and therefore throughput is improved.

Furthermore, the input stream processing unit may output one of the data streams to two of the paths, and one of the two paths may be connected to the operation unit, and the other of the two paths may be directly connected to the output stream processing unit.

According to the stated structure, a data stream that does not require encrypting or decrypting can be input to the input data stream processing unit together with a data stream that does require encrypting or decrypting.

Furthermore, the input stream processing unit may have a crossbar switch, and output each of the data streams to the respective corresponding paths by setting switches in the crossbar on, each of the switches being at a contact point of an input line by which the data stream has been input to the input stream processing unit and an output line that is connected to a path corresponding to the key for encrypting or decrypting the data stream.

According to the stated structure, each data stream can be easily output to the path set for the key corresponding to the data stream.

Furthermore, the parallel stream operation apparatus may further include: a re-input path for re-inputting, into the input stream processing unit, one of the data streams that has already been encrypted or decrypted and output by the operation unit, wherein the operation unit encrypts or decrypts the input data stream that has already been encrypted or decrypted, using a key that is different to a key previously used to encrypt or decrypt the data.

According to the stated structure, encrypted or decrypted data stream can be re-encrypted with a different key. This increases effectiveness of protection of copyrights of the data stream.

Furthermore, the input stream processing unit may multiplex at least two of the plurality of data streams to generate one data stream.

According to the stated structure, encryption or decryption can be performed after generating a new data stream from a plurality of data streams input in parallel.

Furthermore, the input stream processing unit may demultiplex one of the input data streams to generate a plurality of data streams.

According to the stated structure, when, for example, a data stream of a plurality of programs multiplexed together is received, the data stream of the programs can be separated from each other.

Furthermore, the stated objective can be achieved by a parallel stream operation method used in a parallel stream operation apparatus that includes a plurality of paths, each of the paths corresponding to a different one of a plurality of keys used for encrypting and/or decrypting data streams, the method including: an input stream processing step of receiving a plurality of data streams in parallel, and outputting each data stream to a corresponding one of the paths; and an operation step of decrypting or encrypting each data stream with a corresponding one of the keys.

According to the stated method, complicated operations for selecting a key in the operation step each time stream data is input are unnecessary.

Furthermore, the stated object can be achieved by a program that executes the above-described parallel stream operation method in a computer.

By applying this program to a parallel stream operation apparatus that has a plurality of paths that correspond respectively to a plurality of keys for encryption and/or decryption, complicated operations for selecting a key each time stream data is input are unnecessary.

In addition, the stated object can be achieved by a TV reception apparatus that includes the above-described parallel stream operation apparatus.

According to the stated structure, the TV reception apparatus is able to effectively encrypt or decrypt received stream data.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1 is a structural diagram of a conventional parallel stream operation apparatus;

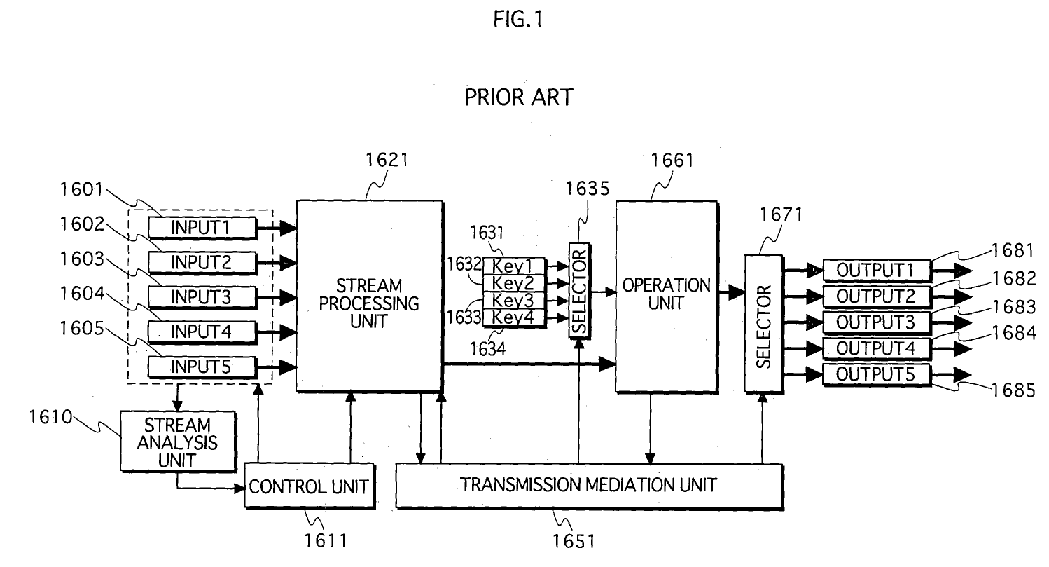

FIG. 2 is a structural diagram of a first embodiment of a parallel stream operation apparatus of the present invention;

FIG. 3 shows the state of a crossbar switch in an input stream processing unit in the first embodiment;

FIG. 4 shows one example of the state of a crossbar switch in an output stream processing unit in the first embodiment;

FIG. 5 shows another example of the state of a crossbar switch in an output stream processing unit in the first embodiment;

FIG. 6 is a flowchart describing operations in the first embodiment;

FIG. 7 is a structural diagram of a second embodiment of a parallel stream operation apparatus of the present invention;

FIG. 8 shows a setting state of a crossbar switch in an input stream processing unit in the second embodiment;

FIG. 9 shows a setting state of a crossbar switch in an output stream processing unit in the second embodiment;

FIG. 10 is a flowchart describing operations in the second embodiment;

FIG. 11 shows a setting state of a crossbar switch in an input stream processing unit in an example of a modification of the second embodiment;

FIG. 12 shows a setting state of a crossbar switch in an output stream processing unit in an example of a modification of the first and second embodiments;

FIG. 13 is a structural diagram of a third embodiment of a parallel stream operation apparatus of the present invention;

FIG. 14 shows a setting state of a crossbar switch in an input stream processing unit in the third embodiment;

FIG. 15 shows a setting state of a crossbar switch in an output stream processing unit in the third embodiment; and

FIG. 16 shows another example of a setting state of the crossbar switch of the output stream processing unit in the third embodiment.

### DETAILED DESCRIPTION OF THE PREFERRED EMBODIMENTS

The following describes embodiments of the parallel stream operation apparatus of the present invention with reference to the drawings.

### First Embodiment

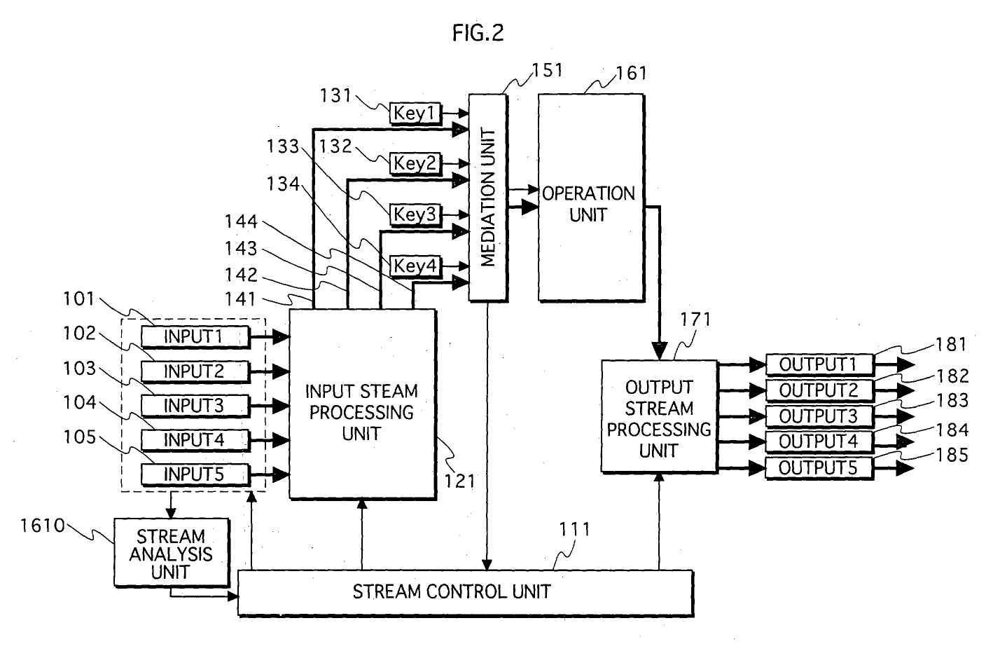

FIG. 2 is a structural diagram of a first embodiment of the parallel stream operation apparatus of the present invention.

The parallel stream operation apparatus is composed of input interfaces 101 to 105, a stream analysis unit 110, a stream control unit 111, an input stream processing unit 121, a mediation unit 151, an operation unit 161, an output stream processing unit 171, and output interfaces 181 to 185. Furthermore, paths 141 to 144 that correspond respectively to keys 131 to 134 are provided between the input stream processing unit 121 and the mediation unit 151.

Note that the parallel stream operation apparatus is part of a TV reception apparatus.

The input interfaces 101 to 105 are connected to an antenna, an external apparatus, a CATV circuit, and a public circuit network, respectively. When one of the input interfaces 101 to 105 receives a data stream, the input interface notifies the stream analysis unit 110 of input stream data, and outputs the stream data to the input stream processing unit 121 in response to an output instruction from the stream control unit 111.

For example, the input interface 101, which is connected to an antenna, receives stream data of a TV broadcast program, and outputs the program to be viewed. The input interface 102 similarly receives stream data of a TV broadcast program, and outputs the program for recording. The input interface 103, which is connected to a DVD drive apparatus, receives stream data that is recorded on a DVD, and outputs the received stream data. The input interface 104, which is connected to a CATV circuit, outputs received stream data. The input interface 105, which is connected to a public circuit network, receives stream data of an Internet broadcast, and outputs the received stream data.

Note that the input interfaces 101 to 105 are changed to be connected to different sources as appropriate.

When a viewer of the TV reception apparatus selects and designates channels of a viewing program and a recording program, a control unit (not illustrated) of the TV reception apparatus sets the antenna, etc. so that the transport stream (TS) of the viewing program is input to the input interface 101, and so that the TS of the recording program is input to the input interface 102. Furthermore, the control unit notifies the stream analysis unit 110 of the PID (packet identifier) of the TS packets of the viewing program and the PID of the TS packets of the recording program, and sets a decryption key for decrypting the encrypted viewing program in the key 131 and a decryption key for decrypting the recording program in the key 132. Furthermore, the control unit instructs the stream control unit 111 to have the data from the input interface 101 output to the path 141, and the data from the input interface 102 output to the path 142. In addition, the control unit instructs the stream control unit 111 to have the decrypted data in the stream processing unit 171 from the path 141 output to the output interface 181, and the decrypted in the data stream processing unit 171 from the path 142 output to the output interface 182.

On receiving input of the viewing program TS, the input interface 101 extracts a TS packet, and notifies the stream analysis unit 110 of the header information of the TS packet.

On receiving an output instruction from the stream control unit 111, the input interface 101 outputs the extracted TS packet to the input stream processing unit 121. Furthermore, on receiving a discard instruction, the input interface 101 discards the extracted TS packet.

On receiving input of the recording program TS, the input interface 102 extracts a TS packet, and notifies the stream analysis unit 110 of the header information of the extracted TS packet.

On receiving an output instruction from the stream control unit 111, the input interface 102 outputs the extracted TS packet to the input stream processing unit 121. Furthermore, on receiving a discard instruction, the input interface 102 discards the extracted TS packet.

The stream analysis unit 110 receives notification of the PID of the TS packets to be extracted from the TS received by the input interface 101, and of the PID of the TS packets to be extracted from the TS received by the input interface 102.

On receiving notification of header information of a TS packet from the input interface 101, the stream analysis unit 110 judges whether the PID in the header information matches the PID notified by the control unit of the TV reception apparatus as the PID of TS packets to be extracted from the TS received by the input interface 101, and notifies the stream control unit 111 of the result of the judgment. Similarly, on receiving notification of header information of a TS packet from the input interface 102, the stream analysis unit 110 judges whether the PID in the header information matches the PID notified by the control unit of the TV reception apparatus as the PID of TS packets to be extracted from the TS received by the input interface 102, and notifies the stream control unit 111 of the result of the judgment.

The stream control unit Ill is instructed by the control unit of the TV reception apparatus to have the data from the input interface 101 output to the path 141 and the data from the input interface 102 output to the path 142. Furthermore, the stream control unit Ill is instructed to have the output stream processing unit 171 have the decrypted data from the path 141 output to the output interface 181 and the decrypted data from the path 142 output to the output interface 182.

Furthermore, the stream control unit 111 receives notification from the stream analysis unit 110 of a result of analyzing the header information of a TS packet, in other words, notification of whether the TS packet has the desired PID. When the TS packet is a TS packet received by the input interface 101, if the result shows that the PIDs match, the stream control unit 111 instructs the input interface 101 to output the TS packet to the input stream processing unit 121. If the result shows that the PTDs do not match, the stream control unit 111 instructs the input interfaces 101 to discard the TS packet. Similarly, when the TS packet is a TS packet received by the input interface 102, if the result shows that the PIDs match, the stream control unit 111 instructs the input interface 102 to output the TS packet to the input stream processing unit 121. If the result shows that the PIDs do not match, the stream control unit 111 instructs the input interface 102 to discard the TS packet.

The stream control unit 111 sets each of the contact points in the crossbar switch in the input stream processing unit 121 on or off, in response to an instruction from the control unit of the TV reception apparatus to output the respective TS packets to the paths 141 and 142.

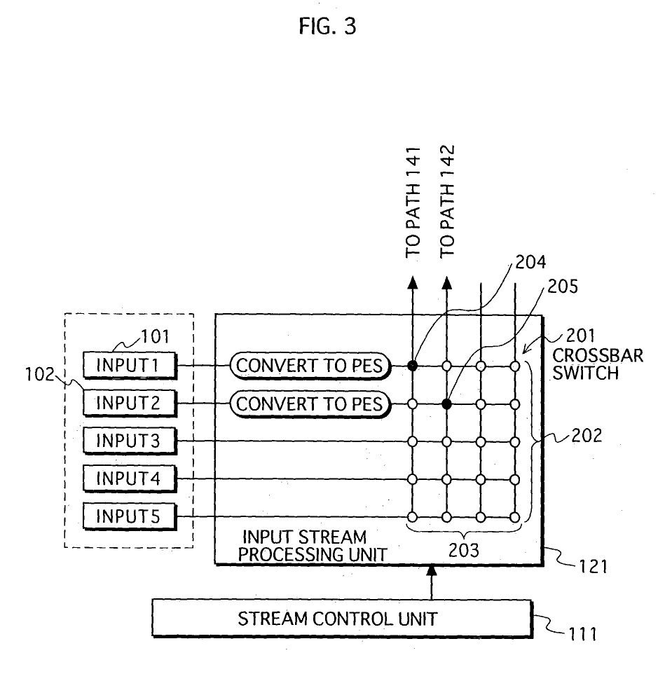

FIG. 3 shows the crossbar switch in the input stream processing unit 121. Here, switches 204 and 205, which are indicated by filled in circles, are on. Switches 204 and 205 are two of the contact points of input lines 202 and output lines 203 in the input stream processing unit 121. The circles that are not filled in indicate switches that are off. This setting results in data from the input interface 101 being output to the path 141 and data from the input interface 102 being output to the path 142.

The stream data control unit 111 receives notification indicating which of the path 141 and the path 142 was used by the mediation unit 151 to output data to the operation unit 161. The stream control unit 111 sets each of the contact points in the crossbar switch in the stream processing unit 171 on or off according to whether the notified path is the path 141 or the path 142, thus setting the output-destination of the data to one of the output interfaces 181 to 185.

On receiving of a TS packet from each of the input interfaces 101 and 102, respectively, the input stream processing unit 121 converts each of the TS packets from stream format that is used for conveying to a format that is usable as content data. The TS packets may be converted, for example, to PES (packetized elementary stream) packet format. The resulting PES packets are output to the paths that correspond to the encryption keys 131 and 132, respectively, that have been set for decrypting encrypted data.

The switches 204 and 205 in the crossbar switch in the input stream processing unit 121 are set on, as shown in FIG. 3. Consequently, the PES packet of the viewing program is output to the path 141, which corresponds to the decryption key 131, and the PES packet of the recording program is output to the path 142, which corresponds to the decryption key 132.

Each of the keys 131 to 134 has a register, and each decryption key that corresponds to a channel selected by the viewer is set in the register of one of the keys by the control unit of the TV reception apparatus.

The mediation unit 151 receives a viewing program PES packet from the path 141, and outputs the received viewing program PES packet together with the decryption key 131 for the viewing program to the operation unit 161. Similarly, the mediation unit 151 receives a recording program PES packet from the path 142, and outputs the received recording program PES packet together with the decryption key 132 for the recording program to the operation unit 161.

Note that in the present embodiment the streams are decrypted in sections (packets), and are therefore output one packet at a time to the operation unit 161. However, when encrypting/decrypting is performed in blocks, it is possible to output the streams one unit of operation at a time. For example, if DES encryption is used, data may be output in units of eight bytes.

In addition, when outputting data to the operation unit 161, the mediation unit 151 notifies the operation unit 161 which path the data was input from.

If the mediation unit 151 receives PES packets from the path 141 and the path 142 simultaneously, the mediation unit 151 gives priority to outputting, for example, the data from the path 141. This is because it is more important to process the viewing program in real time than the recording program. When data is received from all the paths 141 to 144, priority may be given to the data that has not been output for the longest time. Note that here it is assumed that rules for outputting data to the operation unit 161 are set in advance by the control unit of the TV reception apparatus.

The operation unit 161 encrypts or decrypts the input data, and outputs the resulting encrypted or decrypted data to the output stream processing unit 171.

On receiving input from the mediation unit 151 of the decryption key 131 and a PES packet or the decryption key 132 and a PES packet, the operation unit 161 decrypts the PES packet using the corresponding decryption key. The operation unit 161 then outputs the decrypted PES packet to the output stream processing unit 171.

The output stream processing unit 171, which has a crossbar switch, receives data that has been encrypted or decrypted by the operation unit 161, converts control information, such as flag information of the data, and outputs the result to a predetermined output interface.

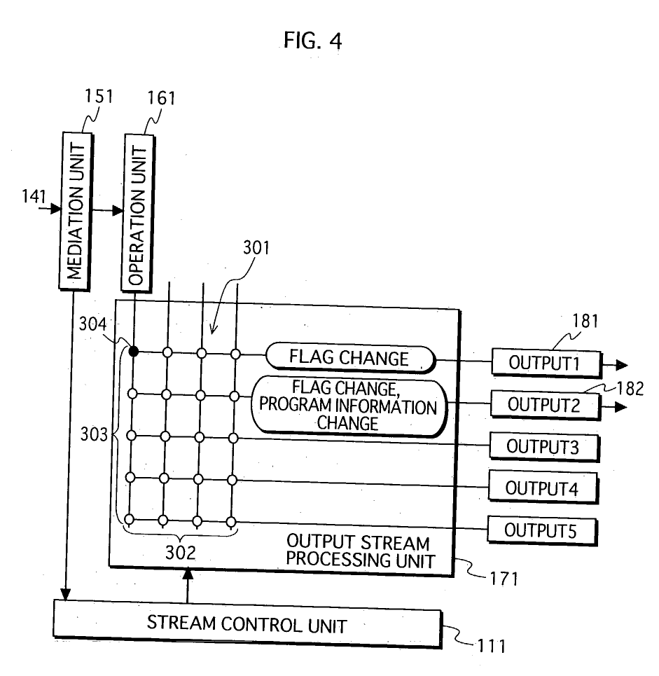

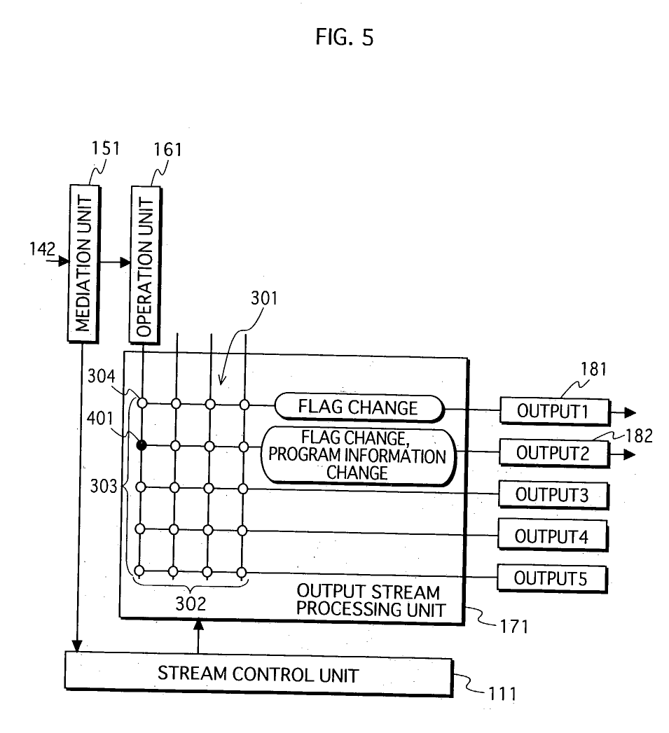

FIGS. 4 and 5 are for describing the state of the crossbar switch in the output stream processing unit 171.

In a crossbar switch 301 in FIG. 4, a contact point 304, which is one contact point of input lines 302 and output lines 303, is set on. This is because the stream control unit 111 has received notification from the mediation unit 151 that the mediation unit 151 has output PES packet data from the path 141, and therefore the stream control unit 111 has set the switch at the contact point 304 on. This enables TS data from the input interface 101 to be decrypted and output from the output interface 181.

The stream processing unit 171 receives data that has been decrypted by the operation unit 161, and therefore the stream processing unit 171, for example, changes a flag in the PES that shows that the PES is encrypted, to show that the PES is not encrypted. Furthermore, if a list of program information is included in the stream, the output stream processing unit 171 deletes any information relating to packets that were discarded by the input interface unit 101 due to the PID not matching the desired PID.

FIG. 5 shows a state in the crossbar switch, when the mediation unit 151 has notified the stream control unit 111 that PES packet data from the path 142 has been output, and the stream control unit 111 has set a contact point 304 off and a contact point 401 on.

The encrypted PES data input from the operation unit 161 is output to the output interface 182 via one of the input lines 302 and one of the output lines 303. At this time, the PES data flag is changed to show that the PES data is not encrypted, and information regarding a program that has been deleted is changed in the program information.

The output interface 181 is connected to a display unit (not illustrated) of the TV reception apparatus, and outputs the decrypted data received from the output stream processing unit 171 to the display unit, thus having the TV program shown on the display unit.

The output interface 182 is connected to a recording unit (not illustrated) that is part of the TV reception apparatus and is an HDD, and outputs decrypted data received from the output stream processing unit 171 to the recording unit, thereby having the TV program recorded.

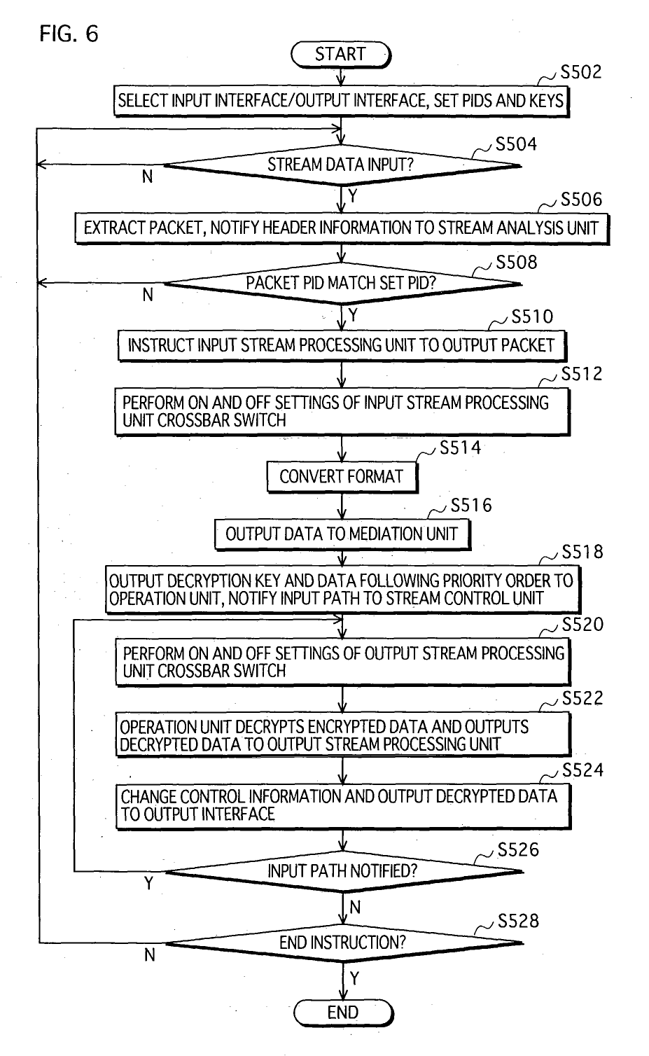

The following describes operations of the present embodiment with use of the flowchart in FIG. 6.

The control unit of the TV reception apparatus selects input interfaces from among the input interfaces 101 to 105 and output interfaces from among the output interfaces 181 to 185, in response to designation of channels of a viewing program and a recording program from the user. The control unit of the TV reception apparatus notifies the stream analysis unit 110 of the respective PIDs of the TS packets to be extracted by the selected input interfaces, and sets the decryption keys of the viewing program and the recording program in respective selected keys from among the keys 131 to 134. Furthermore, the control unit notifies the stream control unit 111 which of the keys 131 to 134 the decryption keys of the viewing program and the recording program have been set in (step S502).

Each of the selected input interfaces 101 and 102 waits for an input of TS data (S504), extracts a TS packet from the respective input data, and notifies the stream analysis unit of 110 of the header information (S506).

The stream analysis unit 110 judges whether the TS packets input to the input interfaces 101 and 102 match the respectively set PIDs (S508). The stream analysis unit 110 notifies the stream control unit 111 of each judgment result.

When either of the judgment results shows that the TS packet does not match the PID, the stream control unit 111 instructs the input interface that received the TS packet to discard the TS packet. The processing then returns to S504. When the judgment results show that the TS packets and the PID match, the stream control unit 111 instructs the input interfaces 101 and 102 to output the packet data to the input stream processing unit 121 (S510).

The stream control unit 111 sets each of the contact points in the crossbar switch 201 of the input stream processing unit 121 on or off, in order to set the paths among the paths 141 to 144 that are to be used for conveying data between the input stream processing unit 121 and the mediation unit 151. The paths are determined according to the settings of the decryption keys notified by the control unit of the TV reception apparatus (S512) The input stream processing unit 121 converts the format of the respective packet data from the input interfaces 101 and 102 to, for example, PES format (S514) and outputs the resulting data to the mediation unit 151 via the paths 141 and 142, respectively (S516).

The mediation unit 151 outputs the decryption keys set corresponding to the paths 141 and 142, respectively, and the data to the operation unit 161. Here, the sets of a decryption key and data are output via the respective paths 141 and 142 following a priority order. In addition, the mediation unit 151 notifies the stream control unit 111 of the input paths 141 and 142 (S518).

The stream control unit 111 sets each of the contact points in the crossbar switch 301 to on or off in order to set the output interfaces among the output interfaces 181 to 185 that are to be used. Here, the selected output interfaces to be used are those that correspond to the paths 141 and 142 from which the operation unit 161 received the data (step S520).

The operation unit 161 applies decryption processing to the input encrypted data, using the decryption key received from the mediation unit 151, and outputs the resulting decrypted data to the output stream processing unit 171 (S522).

The output stream processing unit 171 changes the control information for the decrypted data, and outputs the decrypted data to the output-interfaces 181 and 182, respectively (S524).

The output stream processing unit 171 judges whether notification of the input paths 141 and 142 has been received from the mediation unit 151 (S526), and if notification has been received, the processing returns to step S520. If notification has not been received, the output stream processing unit 171 judges whether an end instruction has been received from the control unit of the TV reception apparatus (S528). If an end instruction has not been received, the processing returns to S504, and if an end instruction has been received, the processing ends.

### Second Embodiment

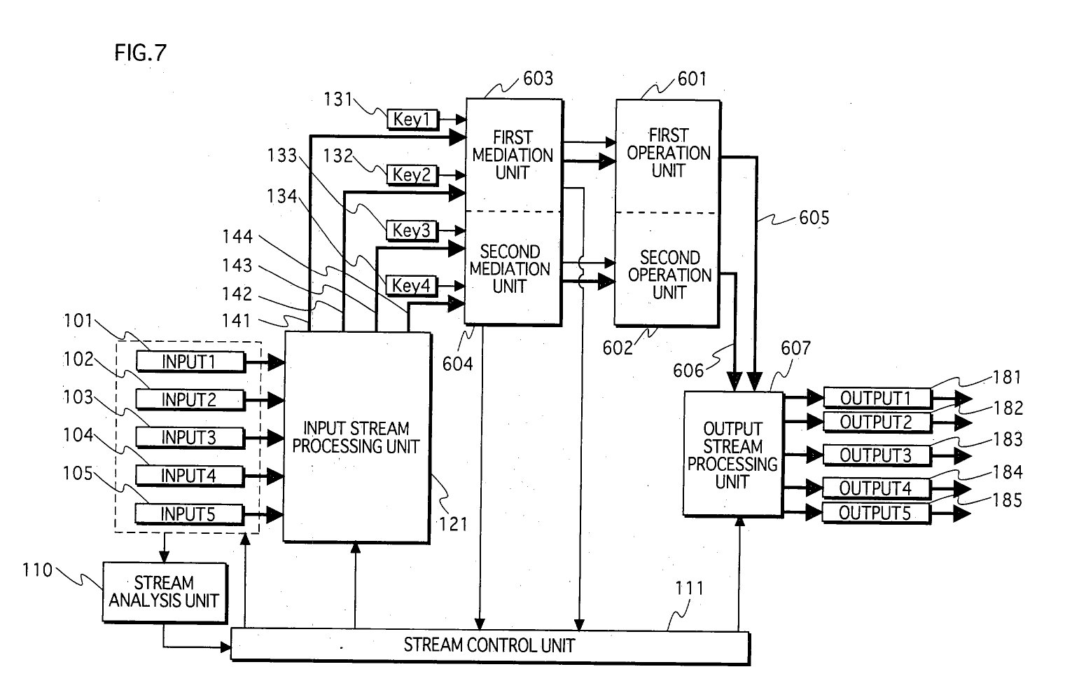

FIG. 7 is a structural diagram of a second embodiment of the parallel stream operation apparatus of the present invention.

The parallel stream operation apparatus has a first operation unit 601 and a second operation unit 602 instead of the operation unit 161 of the parallel stream operation apparatus of the first embodiment. Accordingly, the parallel stream operation apparatus has a first mediation unit 603 and a second mediation unit 604 instead of the mediation unit 151. Furthermore, a path 605 is provided between the first operation unit 601 and the output stream processing unit 607, and a path 606 is provided between the second operation unit 602 and the output stream processing unit 607. Furthermore, connection between the paths 141 to 144 and the first and second mediation units 603 and 604 is performed by the control unit (not illustrated) of the TV reception apparatus, together with the setting of the keys 131 to 134. Note that in the description of in the present embodiment, the paths 141 and 142 are connected in advance to the first mediation unit 603, while the paths 143 and 144 are connected in advance to the second mediation unit 604.

The remaining structure is substantially the same as the first embodiment and therefore is not described here. The following description focuses on structure unique to the present embodiment.

TS packets of a broadcast program in input to the input stream processing unit 121 from the input interface 101, in the same way as in the first embodiment. On the other hand, program stream (PS) packets are input from the input interface 103 to the input stream processing unit 121. The PS packets are input to the input interface 103 from a DVD drive apparatus (not illustrated).

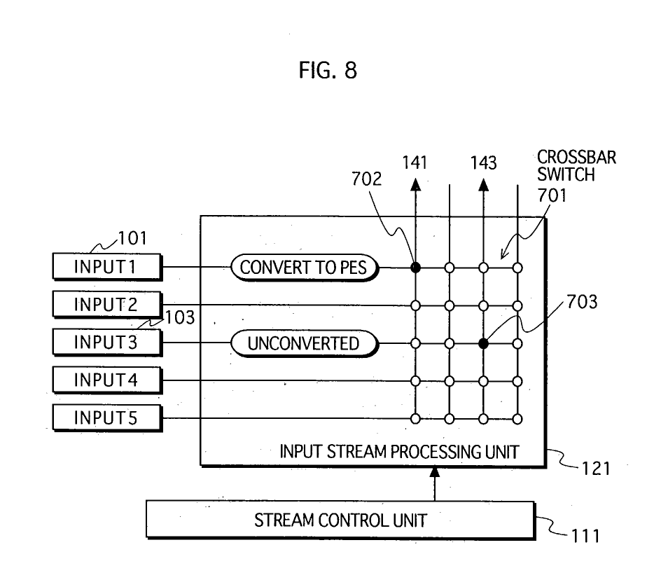

As shown in FIG. 8, contact points 702 and 703 in a crossbar switch 701 in the input stream processing unit 121 are set on by the stream control unit 111.

The input stream processing unit 121 converts the TS packets from the input interface 101 into a PES, and outputs the PES to the path 141. The PS packets from the input interface 103 are output to the path 143 without being converted.

On receiving and input of data in PES format from the path 141, the first mediation unit 603 outputs the data together with the decryption key 131 to the first operation unit 601. Similarly, on receiving PS packet data from the path 143, the second mediation unit 604 outputs the data together with the decryption key 133 to the second operation unit 602.

The first operation unit 601 decrypts the input data with the decryption key 131, and outputs the decrypted data to the output stream processing unit 607 via the path 605.

The second operation unit 602 decrypts the input data with the decryption key 133, and outputs the decrypted data to the output stream processing unit 607 via the path 606.

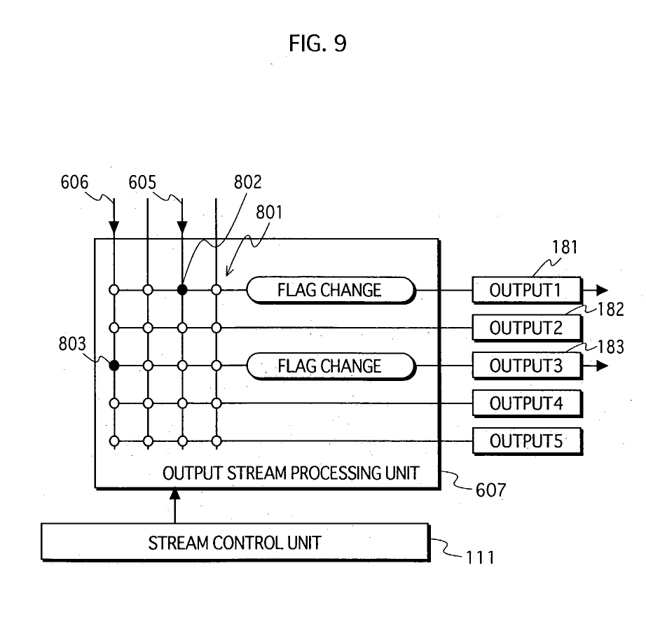

FIG. 9 shows the state of settings of a crossbar switch 801 in the output stream processing 607. A contact point 802 and a contact point 803 are set on by the stream control unit 111. The contact point 802 is the contact point between the input line connected to the path 605 of the decrypted data from the first operation unit 601 and the output line connected to the output interface 181. The contact point 803 is the contact point between the input line connected to the path 606 of the decrypted data from the first operation unit 602 and the output line connected to the output interface 183. According to these settings, the broadcast program PES data decrypted by the first operation unit 601 is converted so that the flag shows that the data is not decrypted, and the resulting data is output to the output interface 181. The output interface 181 receives the data, and outputs the broadcast program to the display unit (not illustrated) of the TV reception apparatus.

The flag of PS data recorded on a DVD and decrypted by the second operation unit 602 is changed by the output stream processing unit 607 to show that the data is not encrypted. The resulting data is output to the output interface 183. The output interface 183 receives the data, and outputs the received data to an external video recording apparatus (not illustrated).

In the present embodiment, the parallel streams input to the input stream processing unit 121 are decrypted in parallel by the first operation unit 601 and the second operation unit 602. By providing the two operation units 601 and 602, it is possible to process two input streams without time division processing. Furthermore, simply setting switch operations for setting the contact points on and off in the crossbar switch 801 in the output stream processing unit 607 once when the stream data is first input eliminates the need to switch each time a path notification is received from the mediation unit 151 as in the first embodiment.

Furthermore, streams that are encrypted using respectively different encryption algorithms, in other words a broadcast program TS and a PS recorded on the DVD, are decrypted separately in the present embodiment. Here, the efficiency of decryption processing is greatly improved when two operation units are used instead of one. This is because processing is performed using time division when only one operation unit is used, whereas processing can be performed without switch operations when two operation units are used.

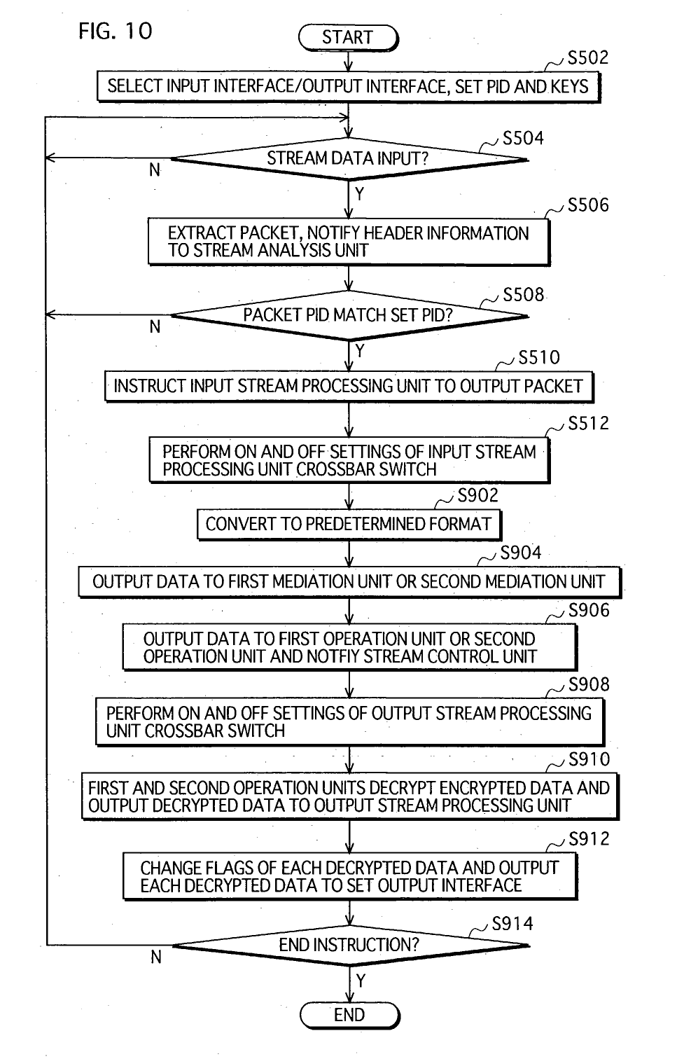

The following describes operations of the present embodiment, with reference to the flowchart shown in FIG. 10.

Note that steps up to and including S512 are the same as in the first embodiment, and therefore are not described here.

At S902 the input stream processing unit 121 converts TS packets input from the input interface 101 to PES-format data, and outputs the PES format data and the PS packet data from the input interface 103 to the first mediation unit 603 and the second mediation unit 604, respectively. Note that the PS packets, are output in PS format without being converted (S904).

The first mediation unit 603 and the second mediation unit 604 output the input data and the corresponding decryption keys 131 and 133 to the first operation unit 601 and the second operation unit 602, respectively. In addition, the first and second mediation units 603 and 604 notify the stream control unit 111 that they have output data to the first and second operation units 601 and 602 (S906).

The stream control unit 111 sets each of the switches in the crossbar switch 801 of the output stream control unit 607 on or off (S908).

The first operation unit 601 and the second operation unit 602 decrypt the input data using the input decryption keys 131 and 133, respectively, and output the decrypted data to the output stream processing unit 607 (S910).

The output stream processing unit 607 changes the flag of each decrypted data stream, and outputs the resulting data to the set output interfaces 181 and 183, respectively (S912).

The stream control unit 111 judges whether an end instruction has been received from the control unit of the TV reception apparatus (S914). The processing returns to S504 if an end instruction has not been received, and ends if an end instruction has been received.

Note that although the first operation unit 601 and the second operation unit 602 are provided in the present embodiment, it is possible to provide the same number or more of operation units as the number of paths 141 to 144 by which data is output from the input stream processing unit 121. In other words, it is possible to provide the same number of operation units as keys 131 to 134, and perform encryption/decryption in parallel. Alternatively, it is possible to provide operation units for different encryption/decryption algorithms. In this case, a corresponding mediation unit must be provided for each operation unit.

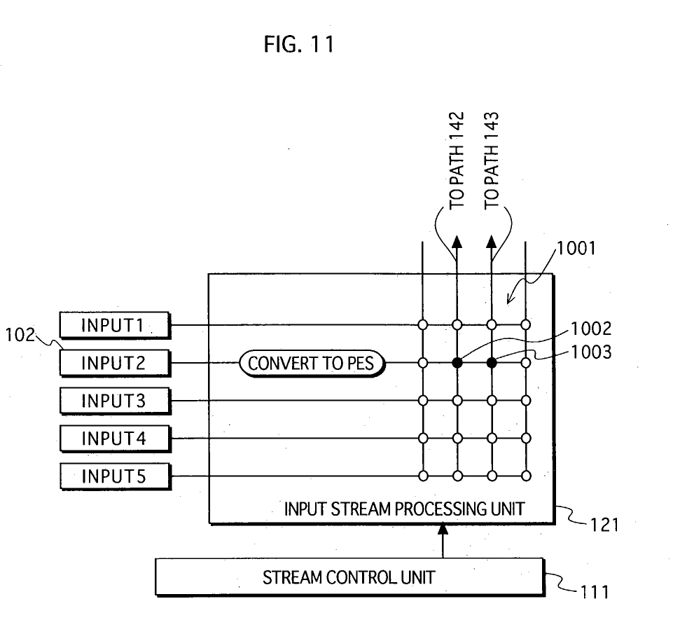

FIG. 11 shows the setting state of a crossbar switch of the input stream processing unit 121 in an example of a modification of the first and second embodiments.

The input stream processing unit 121 outputs data converted into PES format to the paths 142 and 143 because the data is to be output to the output interfaces 182 and 183. This is so that the TS stream of the recording program input from the input interface 102 is stored in the HDD in the TV reception apparatus and also recorded by an external video recording apparatus.

The stream control unit 111 sets contact points 1002 and 1003 in a crossbar switch 1001 on.

Furthermore, as a further example of a modification, when a TS made up of programs from two different channels is received by the input interface 102, the stream analysis unit 110 notifies the stream control unit 111 of the corresponding PID of each channel. The stream control unit 111 sets the two contact points 1002 and 1003 on according to the two PIDs.. As a result, PES packets of the program of one channel are output to the path 142, and PES packets of the program of the other channel are output to the path 143. Here, the TS is demultiplexed by the input stream processing unit 121.

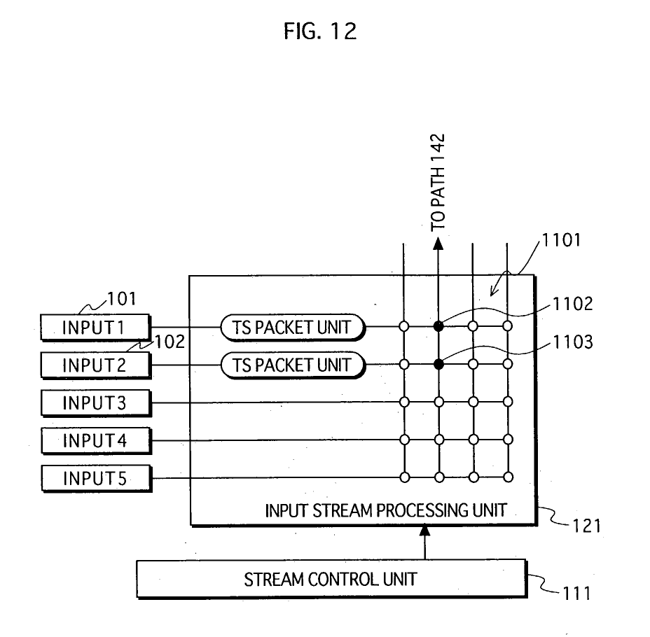

FIG. 12 shows the setting state of a crossbar switch in the input stream processing unit 121 in yet another example of a modification.

Contact points 1102 and 1103 in a crossbar switch 1101 are set on.

A transport stream made up of a first program and a first commercial that is inserted into the first program at regular intervals is received by the input interface 101. A transport stream made up of a second program and a second commercial that is inserted into the second program is received by the input interface 102.

The stream control unit 111 issues an output instruction to output the TS packets of the first program and a discard instruction to discard the TS packets of the first commercial in the input interface 101. In addition, the stream control unit 111 issues an output instruction to discard the TS packets of the second program and an output instruction to output the TS packets of the second commercial in the input interface 101.

The input stream processing unit 121 multiplexes the two output transport streams to generate one transport stream. In other words, one transport stream made up of the TS packet of the first program and the TS packets of the second commercial is output to the path 142.

Note that although in FIGS. 11 and 12 multiplexing and demultiplexing are performed by the input stream processing unit 121, multiplexing and demultiplexing may instead be performed by the output stream processing unit 171 or another compositional element.

### Third Embodiment

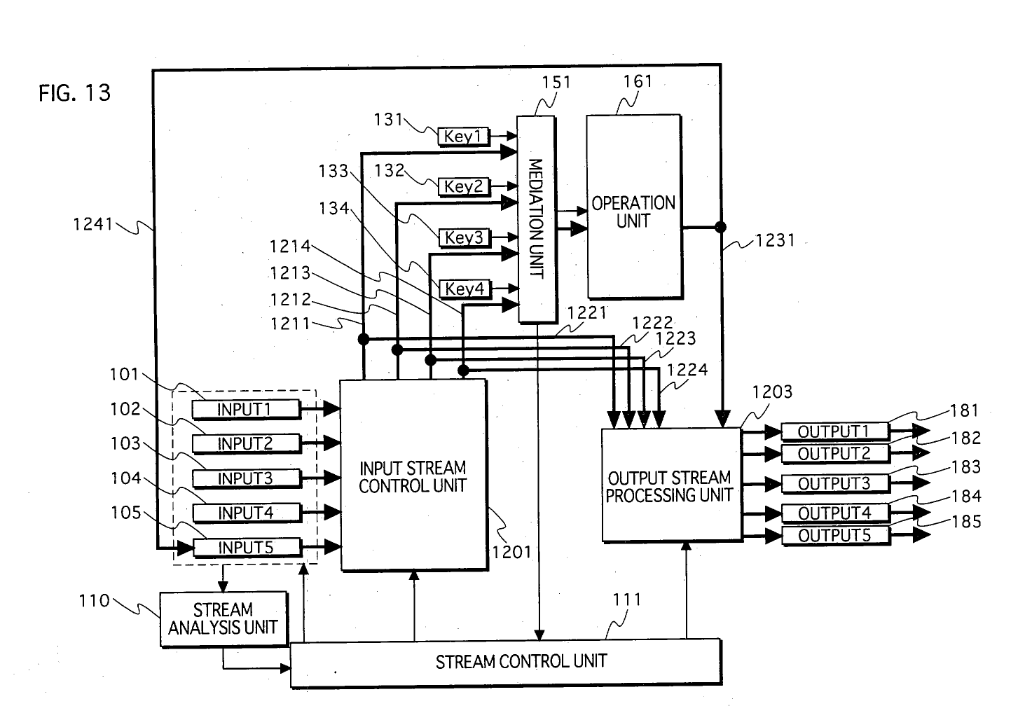

FIG. 13 is a structural diagram of a third embodiment of the parallel stream operation apparatus of the present invention.

The characteristics of this parallel stream operation apparatus that differ from that of the first embodiment are as follows. Branch paths 1221 to 1224 branch from the paths 1211 to 1214, respectively, between an input stream processing unit 1201 and the mediation unit 151, and are connected to the output stream processing unit 1203. In addition, a branch path 1241 braches from the path 1231, between the operation unit 161 and the output stream processing unit 1203, and is connected to the input interface 105.

The following describes structure unique to the present embodiment.

In the present embodiment, the input interface 101 receives an input of an encrypted program TS which is viewed as well as being recorded to an internal HDD of the parallel stream operation apparatus in an encrypted state. In addition, after being decrypted, the program is re-encrypted with another encryption key, and recorded by an external video recording apparatus.

The output interface 181 outputs the decrypted data to the display unit of the TV reception apparatus, the output interface 182 outputs the encrypted data as is to the HDD, and the output interface 183 outputs the re-encrypted data to the external video recording apparatus.

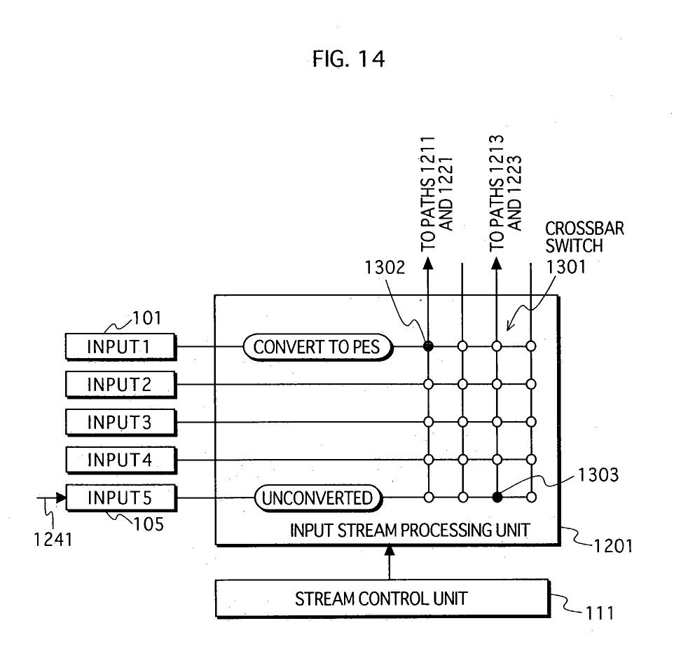

FIG. 14 shows the setting state of a crossbar switch in the input processing unit 1201. In a crossbar switch 1301, contact points 1302 and 1303 are set on.

The input interface 101 outputs a TS packet to the input stream processing unit 1201 in response to an output instruction from the stream control unit 111. The input stream processing unit 1201 converts the TS packet to a PES packet which is then output to the paths 1211 and 1221 via the crossbar switch 1301. The data input to the path 1221 is input directly into the output stream processing unit 1203. The PES-format packet output from the path 1211 is output to the mediation unit 151.

The mediation unit 151 outputs the PES-format packet and the decryption key 131 to the operation unit 161, and notifies the stream control unit 111 that the data from the path 1211 has been output to the operation unit 161.

The operation unit 161 decrypts the input data with the decryption key 131, and outputs the decrypted data to the paths 1231 and 1241. The decrypted data output to the path 1231 is input to the output stream processing unit 1203.

The decrypted data output to the path 1241 is input to the input interface 105. When the data input to the input interface 105 is data that has been output via the path 1211, the stream control unit 111 issues an output instruction to the input stream processing unit 1201.

Note that when the input interface 105 receives data from the path 1241 that has been conveyed via the path 1213, the stream control unit 111 issues an instruction to discard the data.

The input stream processing unit 1201 outputs, without converting, decrypted data received from the input interface 105 to the paths 1213 and 1223, via the crossbar switch 1301. Here, the data is not converted because it is already in PES format.

The decrypted data output to the path 1223 is input to the output stream processing unit 1203.

The data output to the path 1213 is input to the mediation unit 151. The mediation unit 151 outputs this data and the encryption key 133 to the operation unit 161, and notifies the stream control unit 111 that the data input from the path 1213 has been output to the operation unit 161.

The operation unit 161 encrypts the data using the encryption key 133, and outputs the encrypted data to the paths 1231 and 1241. The encrypted data output to the path 1231 is input to the output steam processing unit 1203, and the encrypted data output to the path 1241 is input to the input interface 105 once more. Note that this encrypted data is discarded by the input interface 105 according to an instruction from the stream control unit 111, as described earlier.

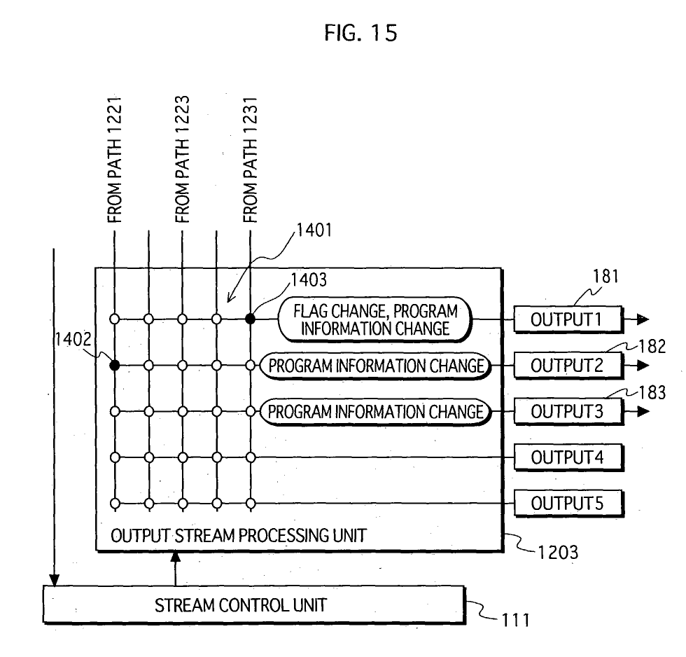

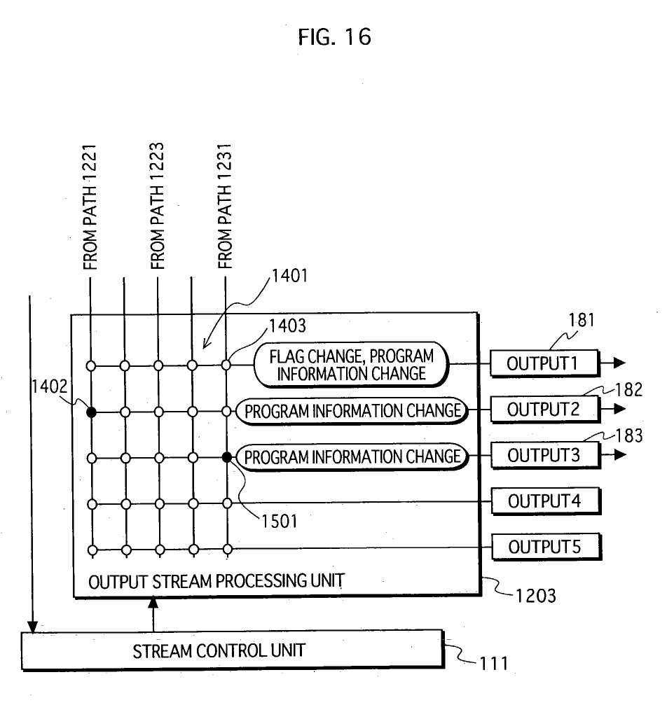

FIGS. 15 and 16 shows setting states of a crossbar switch in the output stream control unit 1203. In FIG. 15, contact points 1402 and 1403 in a crossbar switch 1401 are set on.

The output stream unit 1203 changes the program information of the encrypted data input from the path 1221, and outputs the resulting data to the output interface 182.

Furthermore, the output stream unit 1203 changes the flag of decrypted data received from the path 1231 via the path 1211 to show that the data is not encrypted, and outputs the decrypted data, the program information and the flag to the output interface 181.

Next, when the output stream processing unit 1203 receives re-encrypted data from the path 1231 that has been conveyed via the path 1213, the stream control unit 111 sets a contact point 1403 off and a contact point 1501 on in the crossbar switch 1401. As a result, the program information of the re-encrypted data is changed, and the re-encrypted data is output to the output interface 183.

Note that data input from the path 1223 is not output from the output interface because all the contact points connected to the path 123 are set off in the crossbar switch 1401.

Note also that the decryption key 131 and the encryption key 133 are set by the control unit of the TV reception apparatus, and notified to the stream control unit 111.

In the present embodiment, the reason for re-encrypting data output to the output interface 183 for recording by the external video recording apparatus is to protect the copyrights of the data.

Operations in the present embodiment are essentially the same as those in the first embodiment, and therefore a description thereof is omitted.

Note that in the above-described embodiments, the keys 131 to 134 are set in advance by the control unit of the TV reception apparatus in accordance with the stream data input from the input interfaces 101 to 105. The keys are obtained, for example, from a card inserted into the TV reception apparatus, or from received stream data in which they are incorporated.

Furthermore, although stream data input from the input interfaces in described mainly as TS data in the embodiments, the stream data may be PS (program stream) data recorded on a DVD.

Although structural diagrams of the embodiments are shown in FIGS. 2, 7 and 13, the present invention may be implemented by a computer program that realizes the function of each compositional element in a computer. This program may be recorded on a computer-readable recording medium and applied to a parallel stream operation apparatus. Furthermore, this program may be recorded on a site on the Internet, and downloaded and applied to a parallel stream operation apparatus.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A parallel stream operation apparatus, comprising:
a plurality of paths, each corresponding to a different one of a plurality of keys used for encrypting and/or decrypting data streams;
an input stream processing unit operable to receive a plurality of data streams in parallel, and output each data stream to a corresponding one of the paths; and
an operation unit operable to decrypt or encrypt each data stream with a corresponding one of the keys.

2. The parallel stream operation apparatus of claim 1, further comprising:
an output stream processing unit operable to receive the plurality of data streams that have been decrypted or encrypted by the operation unit, and output each received data stream to a different one of a plurality of output interfaces.

3. The parallel stream operation apparatus of claim 2, wherein
the output stream processing unit includes a crossbar switch, and
the parallel stream operation apparatus further comprises:
a switch control unit operable to set each contact point in the crossbar switch on or off, thereby setting a plurality of output interfaces as output destinations to which the output stream processing unit is to output the encrypted or decrypted data streams, the output interfaces being determined according to which of the paths the data streams were output to by the input stream processing unit; and
a notification unit operable to receive each data stream from the paths, output each received data stream and the corresponding key to the operation unit, and notify the switch control unit of path information of each input data stream.

4. The parallel stream operation apparatus of claim 2, wherein
the operation unit is one of a plurality of operation units in the parallel stream operation apparatus, and
the parallel stream operation apparatus further comprises:
a notification unit operable to receive the plurality of data streams from the paths, input in parallel each of the plurality of received data streams and the corresponding key to a different one of the operations units, and notify each operation unit of path information of the data stream input to the operation unit; and
a selection control unit operable, for each of the encrypted or decrypted data streams output from the output stream processing unit, to select, according to the path information of the data stream, an output interface as an output destination of the data stream.

5. The parallel stream operation apparatus of claim 2, wherein
the input stream processing unit outputs one of the data streams to two of the paths, and
one of the two paths is connected to the operation unit, and the other of the two paths is directly connected to the output stream processing unit.

6. The parallel stream operation apparatus of claim 1, wherein
the input stream processing unit has a crossbar switch, and outputs each of the data streams to the respective corresponding paths by setting switches in the crossbar on, each of the switches being at a contact point of an input line by which the data stream has been input to the input stream processing unit and an output line that is connected to a path corresponding to the key for encrypting or decrypting the data stream.

7. The parallel stream operation apparatus of claim 1, further comprising:
a re-input path for re-inputting, into the input stream processing unit, one of the data streams that has already been encrypted or decrypted and output by the operation unit,
wherein the operation unit encrypts or decrypts the input data stream that has already been encrypted or decrypted, using a key that is different to a key previously used to encrypt or decrypt the data.

8. The parallel stream operation apparatus of claim 1, wherein
the input stream processing unit multiplexes at least two of the plurality of data streams to generate one data stream.

9. The parallel stream operation apparatus of claim 1, wherein
the input stream processing unit demultiplexes one of the input data streams to generate a plurality of data streams.

10. A parallel stream operation method used in a parallel stream operation apparatus that includes a plurality of paths, each of the paths corresponding to a different one of a plurality of keys used for encrypting and/or decrypting data streams, the method comprising:
an input stream processing step of receiving a plurality of data streams in parallel, and outputting each data stream to a corresponding one of the paths; and
an operation step of decrypting or encrypting each data stream with a corresponding one of the keys.

11. A parallel stream operation program executed in a computer in a parallel stream operation apparatus that includes a plurality of paths, each of the paths corresponding to a different one of a plurality of keys used for encrypting and/or decrypting data streams, the program comprising:
an input stream processing step of receiving a plurality of data streams in parallel, and outputting each data stream to a corresponding one of the paths; and
an operation step of decrypting or encrypting each data stream with a corresponding one of the keys.

12. A television reception apparatus, comprising:
a plurality of paths, each corresponding to a different one of a plurality of keys used for encrypting and/or decrypting data streams;
an input stream processing unit operable to receive a plurality of data streams in parallel, and output each data stream to a corresponding one of the paths; and
an operation unit operable to decrypt or encrypt each data stream with a corresponding one of the keys.
